(19) United States
(12) Patent Application Publication
(10) Pub. No.: US 2007/0242416 A1
(43) Pub. Date: Oct. 18, 2007

(54) SURFACE-MOUNTING CERAMIC ELECTRONIC COMPONENT

(75) Inventors: Kenji Saito, Gunma (JP); Shoji Shibasaki, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/696,067

(22) Filed: Apr. 3, 2007

(30) Foreign Application Priority Data
Apr. 4, 2006 (JP) 2006-127927

(51) Int. Cl. H01G 4/06; H01G 2/20; C04B 35/64

(52) U.S. Cl. 361/321.1; 361/308.1; 264/618

(57) ABSTRACT

One inventive aspect relates to a surface-mounting ceramic electronic component including a terminal electrode structure which improves the mechanical strength of the electronic component. In the terminal electrode structure, an intermediate metal layer is formed on a base metal layer, and a conductive resin layer is formed thereon. A surface of the base metal layer in which a common material, an oxide film, glass frit or the like exists is covered with the intermediate metal layer, and the conductive resin layer is adhered to the intermediate metal layer as a tight metal surface.

### BACKGROUND OF THE INVENTION

1. Field of the Invention

The present invention relates to a surface-mounting ceramic electronic component such as ceramic capacitor, multilayer inductor, chip resistor, chip varistor, chip thermistor, and capacitor array, and particularly relates to a structure of a terminal electrode (external electrode).

2. Description of the Related Technology

In recent years, progress has been made in reduction in size of electronic devices, and a surface-mounting electronic component advantageous for high-density package is increasingly used. As shown in FIG. 5, a surface-mounting ceramic electronic component 19 is directly connected to a wiring board 20 by means of a mounter or the like, and fixed by reflow soldering or the like. As such a surface-mounting ceramic electronic component, a component including a square electronic component body having a pair of terminal electrodes formed thereon, such as multilayer ceramic capacitor, multilayer inductor, chip resistor, chip varistor, and chip thermistor, and a component including an electronic component body having sides on which several pairs of terminal electrodes are formed, such as a multi-terminal capacitor or capacitor array are given.

Taking the multilayer ceramic capacitor as an example, as shown in FIG. 6, the surface-mounting ceramic electronic component has a configuration where a pair of terminal electrodes (external electrodes) 5 are formed on an electronic component body 2 in which internal electrodes 3 forming capacitance are alternately stacked via a dielectric ceramic layer 4 containing barium titanate as a main component. The terminal electrode 5 has a base metal layer 5a being adhered to the electronic component body 2, and electrically connected to the internal electrodes 3; a Ni plating metal layer 5d formed on the base metal layer 5a; and a Sn plating metal layer 5e formed thereon for improving solderability. The base metal layer 5a is obtained in the following way. That is, a conductive paste mixed with ceramic powder having the same composition as that of the electronic component body as a common material is coated on an unburned electronic component body, and then baked at the same time as burning of the electronic component body to form the layer 5a. Alternatively, a conductive paste mixed with glass frit is coated on a burned electronic component body, and then baked to form the layer 5a.

Since the surface-mounting ceramic electronic component includes ceramic and metal in this way, the component is poor in elasticity, and brittle to strong external force such as shock given by a mounter during mounting, deflection of a wiring board after mounting, and dropping, consequently a defect such as crack is apt to occur. Thus, to solve such a difficulty, an electronic component (multilayer ceramic capacitor 1″) is proposed, which has a terminal electrode 5 added with a conductive resin layer 5c, having low Young's modulus compared with metal, on the base metal layer 5a, as shown in Japanese Patent No. 3359522, JP-A-2000-182879, and FIG. 7. Here, conductive resin is a material including thermosetting resin such as epoxy resin or phenol resin kneaded with conductive metal powder such as Ag powder or Ni powder. It is considered that the terminal electrodes can be provided with ductility by forming the conductive resin layer on the base metal layer, thereby external force can be relaxed, and therefore mechanical strength of the surface-mounting ceramic electronic component can be improved.

However, it was found that in the terminal electrode in which the conductive resin layer was directly formed on the base metal layer, when the electrode was applied with deflection of a wiring board after mounting or mechanical shock by dropping, or when the electrode was subjected to a heat cycle test, the conductive resin layer was separated, consequently desired mechanical strength was hardly obtained.

### SUMMARY OF CERTAIN INVENTIVE ASPECTS

To solve such a difficulty, an embodiment of the invention proposes a surface-mounting ceramic electronic component having terminal electrodes in which adhesion strength between the base metal layer and the conductive resin is secured, consequently mechanical strength can be improved.

An embodiment of the invention proposes a surface-mounting ceramic electronic component having an electronic component body, and at least a pair of terminal electrodes formed on a surface of the electronic component body, wherein each of the terminal electrodes includes a base metal layer including a common material or glass frit formed on a surface of the electronic component body, an intermediate metal layer being formed on the base metal layer, a conductive resin layer formed on the intermediate metal layer, and a plating metal layer formed on the conductive resin layer.

According to an embodiment of the invention, the intermediate metal layer is provided between the base metal layer and the conductive resin layer, thereby a surface of the base metal layer in which the common material, an oxide film, the glass frit or the like exists is covered with the intermediate metal layer, and the conductive resin layer is adhered to the intermediate metal layer having the smooth and tight metal surface compared with the base metal layer. According to the structure, soft and tough terminal electrodes can be formed. Here, the smooth and tight metal surface means a metal surface in a condition of being free from pores, and including substantially metal particles only such as plating metal or an evaporated metal film.

Moreover, an embodiment of the invention proposes a surface-mounting ceramic electronic component wherein the intermediate metal layer has a thickness of metal layer of about 0.5 μm to 10 μm. According to an embodiment of the invention, the base metal layer can be adhered to the conductive resin layer more firmly, and resistance to heat shock such as solder dip resistance can be secured. In one embodiment, the thickness of metal layer is obtained in the following way. That is, on a section of a terminal electrode observed by SEM at a magnification of ×3000, thickness is measured by an attached micrometer at 4 places in total of 2 places in an end face portion and 2 places in a side face portion for one electronic component. Such measurement is performed for 10 electronic components, and an average value for the components is obtained as the thickness of metal layer.

Furthermore, an embodiment of the invention proposes a surface-mounting ceramic electronic component wherein the intermediate metal layer has a continuity modulus of metal layer of at least about 20%. According to an embodiment of the invention, the conductive resin layer can be adhered to the intermediate metal layer more firmly. The continuity modulus described herein shows a ratio of length over which the intermediate metal layer exists to length of an outer edge portion of the base metal layer on a section of a terminal electrode. The ratio is, for example, measured in the following way. That is, the length of the outer edge portion of the base metal layer and the length over which the intermediate metal layer exists are measured by a micrometer in a region observed by SEM at a magnification of ×3000. Such measurement is performed at 4 places in total of 2 places in an end face portion and 2 places in a side face portion for one electronic component. In this way, 10 samples are subjected to the measurement, and an average value for the samples is obtained as the ratio.

According to an embodiment of the invention, a terminal electrode can be obtained, in which the conductive resin layer is hardly separated. Accordingly, a surface-mounting ceramic electronic component can be obtained, which has improved mechanical strength against external force such as deflection or dropping.

### BRIEF DESCRIPTION OF THE DRAWINGS

FIG. 1 is a schematic diagram of a vertical section of a multilayer ceramic capacitor showing a first embodiment of the invention;

FIG. 2 is a schematic diagram of a vertical section of a multilayer inductor showing a second embodiment of the invention;

FIG. 3 is a schematic diagram of a vertical section of a chip resistor showing a third embodiment of the invention;

FIG. 4 is an enlarged diagram of a portion A enclosed by a dotted line in FIG. 1;

FIG. 5 is a diagram showing an aspect that a surface-mounting ceramic electronic component is mounted on a wiring board;

FIG. 6 is a schematic diagram of a vertical section of a multilayer ceramic capacitor having a usual terminal electrode structure;

FIG. 7 is a schematic diagram of a vertical section of a multilayer ceramic capacitor having a usual terminal electrode structure; and

FIG. 8 is graph showing a result of a deflection test of example 1, example 2, comparative example 1, and comparative example 2.

### DESCRIPTION OF CERTAIN ILLUSTRATIVE EMBODIMENTS

The reason why desired mechanical strength was hardly obtained in a terminal electrode wherein the conductive resin layer was directly formed on a base metal layer is as follows. In the terminal electrode in which the base metal layer is burned at the same time as burning of the electronic component body, a surface of the base metal layer is sometimes in a condition of being not a smooth and tight metal surface due to presence of pores produced by escape of the common material, an oxide film, or a binder, therefore adhesion strength between the base metal layer and the conductive resin layer cannot be sufficiently secured. In the terminal electrode formed by baking the base metal layer after burning of the electronic component body, adhesion strength between the base metal layer and the conductive resin layer cannot be sufficiently secured due to the pores, in addition, segregation of the glass frit to a surface in some cases. Certain embodiments as will be described below are targeted for dealing with this problem.

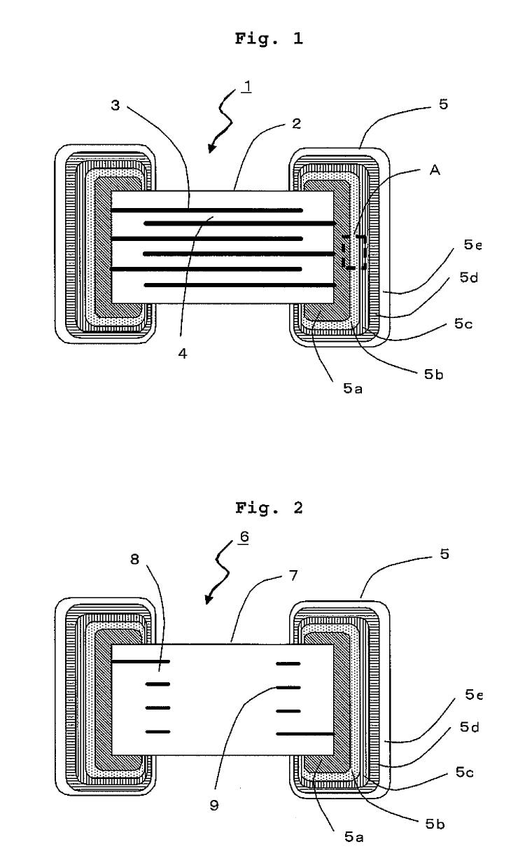

A first embodiment of a surface-mounting ceramic electronic component is described according to FIG. 1 and FIG. 4. FIG. 1 is a schematic, vertical section diagram showing a multilayer ceramic capacitor according to an embodiment of the invention. The multilayer ceramic capacitor 1 has a structure where a pair of terminal electrodes (external electrodes) 5 are formed on an electronic component body 2 in which internal electrodes 3 are alternately stacked via a dielectric ceramic layer 4 containing barium titanate as a main component. Each of the terminal electrodes 5 has a base metal layer 5a being adhered to the electronic component body 2, and electrically connected to the internal electrodes 3; an intermediate metal layer 5b formed on the base metal layer 5a; a conductive resin layer 5c formed on the intermediate metal layer 5b; a plating metal layer 5d formed on the conductive resin layer 5c, and a Sn plating metal layer 5e formed thereon for improving solderability.

Such a multilayer ceramic capacitor 1 is obtained, for example, in the following way. First, ceramic powder having reduction resistance, which contains barium titanate as a main component, is kneaded with an organic binder so that slurry is formed, then the slurry is formed in a sheet shape using a doctor blade or the like to obtain a ceramic green sheet. A Ni conductive paste is coated on the ceramic green sheet in a predetermined pattern by screen printing to form internal electrodes. The ceramic green sheet having an internal electrode pattern formed thereon is stamped into a predetermined shape, and a predetermined number of the stamped ceramic green sheets are piled such that certain capacitance can be produced, then subjected to thermocompression bonding to obtain a layered product. The layered product is cut and divided into individual chips having a predetermined size so that a non-burned body of the electronic component body 2 is obtained. A conductive paste including a common material is coated by dipping on an exposed surface of internal electrode of the un-burned body, and then burned in a nitrogen-hydrogen atmosphere at about 1100 to 1300° C., consequently the electronic component body 2 and the base metal layer 5a are formed. The base metal layer 5a may be formed in a manner that the un-burned body is burned, then a conductive paste including glass frit is coated by dipping, and then burned in a nitrogen atmosphere at about 700 to 800° C. As a metal used for the base metal layer 5a, Ni, Cu, Ag or alloy thereof is given. While thickness of the base metal layer 5a is varied depending on chip size, about 15 to 25 μm is preferable for thickness of the exposed surface of internal electrode in a chip size of 1.6×0.8 mm to 3.2×1.6 mm.

Next, the intermediate metal layer 5b is formed on the base metal layer 5a. As a method of forming the intermediate metal layer 5b, an evaporation method or a sputtering method is given in addition to electroless plating or electroplating. As a metal used for the intermediate metal layer 5b, Au, Pt, Pd, Ag, Cu, Ni or the like is given. Among them, Cu or Ag having a low resistivity value is desirable in the light of controlling a resistance value by a level corresponding to increase of the intermediate metal layer, and Cu or Ni being small in diffusibility is desirable in the light of protecting the base metal layer. In the light of preventing formation of an oxide film, which inhibits adhesion to the conductive resin layer, on the intermediate metal layer, the noble metal such as Au, Pt, Pd, Ag or Cu is desirable.

Next, the conductive resin layer 5c is formed on the intermediate metal layer 5b. The layer 5c may be obtained in the following way. That is, thermosetting resin such as epoxy resin or phenol resin kneaded with conductive filler such as Ag, Ni or Cu is coated by dipping on an area of the intermediate metal layer 5b, and then subjected to heat treatment to be hardened, thereby the conductive resin layer 5c is obtained. As a thickness of the conductive resin layer 5c, about 10 to 30 μm is preferable for thickness of an exposed surface of internal electrode in an approximate size of 1.6×0.8 mm to 3.2×1.6 mm, Next, the plating metal layer 5d and the Sn plating metal layer 5e are sequentially formed on the conductive resin layer 5c by Ni electroplating and Sn electroplating respectively.

A mechanism that the terminal electrode 5 of the multilayer ceramic capacitor 1 obtained in this way exhibits advantages of an embodiment of the invention is described according to FIG. 4. FIG. 4 is an enlarged diagram of a portion A enclosed by a dotted line in FIG. 1. The base metal layer 5a includes a conductive metal 15 and a common material 16. The common material 16 is exposed in places of an outer surface of the base metal layer 5a, and such an exposed common material has usually inhibited adhesion to the conductive resin layer 5c. The intermediate metal layer 5b covers a surface of the base metal layer 5a, thereby the common material 16 is also covered, consequently the conductive resin layer 5c is adhered on the intermediate metal layer 5b having a smooth and tight metal surface compared with the base metal layer 5a. The conductive resin layer 5c, in which conductive filler including Ag, Ni or Cu is dispersed in a resin 18, exhibits flexibility for conductive connection and external force.

Next, a second embodiment of a surface-mounting ceramic electronic component is described according to FIG. 2. FIG. 2 is a schematic, vertical section diagram showing a multilayer inductor according to an embodiment of the invention. The multilayer inductor 6 has a structure where a pair of terminal electrodes (external electrodes) 5 are formed on an electronic component body 7 in which a coil conductor 9 is spirally formed in a magnetic ceramic layer 8 containing Ni—Zn—Cu ferrite as a main component. Each of the terminal electrodes 5 has a base metal layer 5a being adhered to the electronic component body 7, and electrically connected to the coil conductor 9; an intermediate metal layer 5b formed on the base metal layer 5a; a conductive resin layer 5c formed on the intermediate metal layer 5b; a plating metal layer 5d formed on the conductive resin layer 5c; and a Sn plating metal layer 5e formed thereon for improving solderability.

Such a multilayer inductor 6 is obtained, for example, in the following way. First, magnetic powder containing Ni—Zn—Cu ferrite as a main component is kneaded with an organic binder so that slurry is formed, then the slurry is formed in a sheet shape using a doctor blade or the like to obtain a magnetic sheet. The magnetic sheet is perforated to form throughholes, then an Ag conductive paste is coated on the magnetic sheet in a predetermined pattern by screen printing so that a coil pattern and throughhole conductors are formed. The magnetic sheet having the coil pattern is stamped into a predetermined shape, and a predetermined number of the stamped magnetic sheets are piled such that coil patterns can be electrically connected to one another through the throughhole conductors, and then subjected to thermocompression bonding to obtain a layered product. The layered product is cut and divided into individual chips having a predetermined size so that a non-burned body of the electronic component body 7 is obtained. An Ag conductive paste including glass frit is coated by dipping on an exposed surface of coil conductor of the un-burned body, and then burned in air at about 900° C., consequently the electronic component body 7 and the base metal layer 5a are formed.

Next, similarly as in the first embodiment, an intermediate metal layer 5b including noble metal, a conductive resin layer 5c including thermosetting resin dispersed with conductive filler, a plating metal layer 5d formed by Ni electroplating, and a Sn plating metal layer 5e are sequentially formed on the base metal layer 5a. The multilayer inductor 6 obtained in this way provides the same advantages as those in the first embodiment.

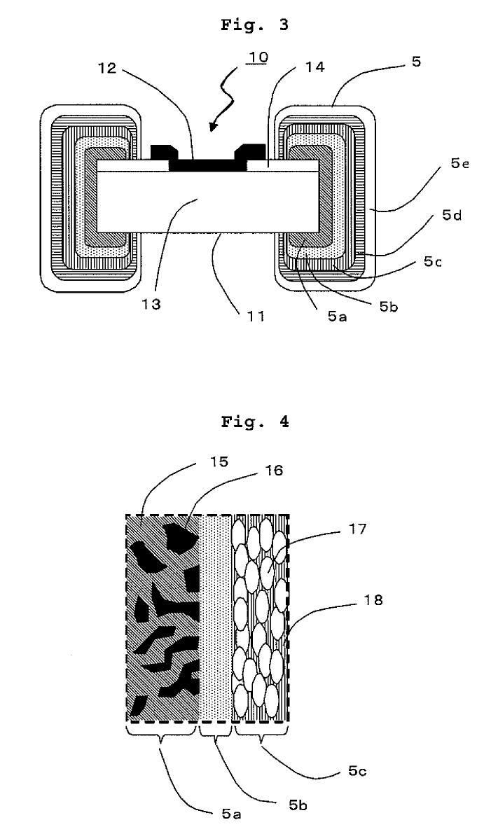

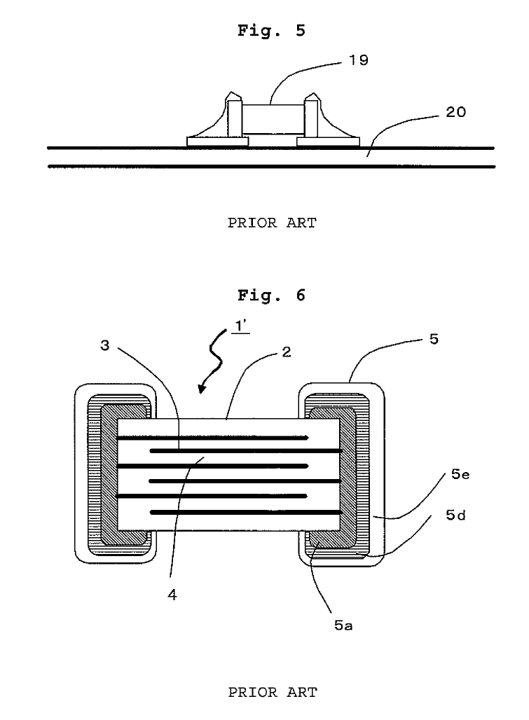

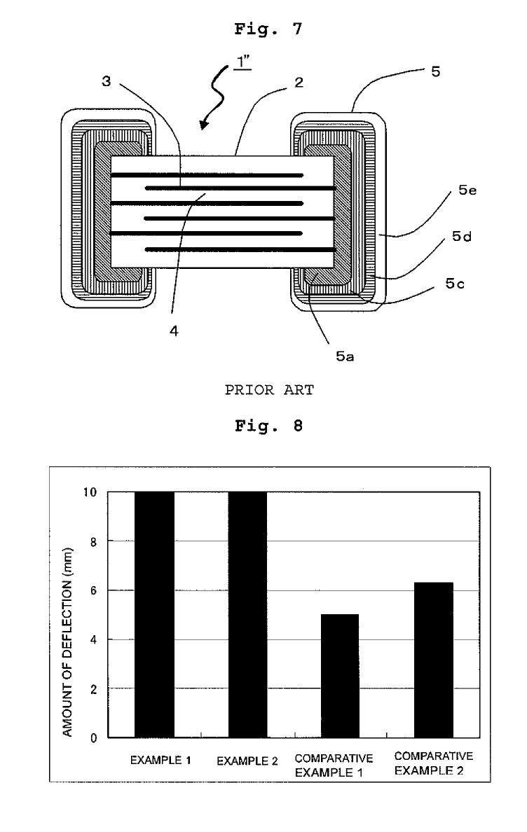

Next, a third embodiment of a surface-mounting ceramic electronic component is described according to FIG. 3. FIG. 3 is a schematic, vertical section diagram showing a chip resistor according to an embodiment of the invention. The chip resistor 10 has a structure where a pair of terminal electrodes (external electrodes) 5 are formed on an electronic component body 11 in which a resistor material 12, protective layer (not shown), and leads 14 are formed on an insulating substrate 13 containing alumina as a main component. Each of the terminal electrodes 5 has a base metal layer 5a being adhered to the electronic component body 11, and electrically connected to the lead 14; an intermediate metal layer 5b formed on the base metal layer 5a; a conductive resin layer 5c formed on the intermediate metal layer 5b; a plating metal layer 5d formed on the conductive resin layer 5c; and a Sn plating metal layer 5e formed thereon for improving solderability.

Such a chip resistor 10 is obtained, for example, in the following way. First, an insulating substrate containing alumina as a main component is prepared, then an Ag conductive paste is coated on the substrate by screen printing, thereby a thick-film pattern to be the leads is formed, and then the Ag conductive paste is baked. Then, a resistor material containing ruthenium oxide as a main component is coated by screen printing between the two leads, and then the resistor material is baked. The resistor material is adjusted in resistance value by trimming, then a protective layer including borosilicate glass is formed on the resistor material, and then the insulating substrate is divided into individual chips, and then an Ag conductive paste including glass frit is coated by dipping so as to cover end faces of a chip and part of the leads, and then burned in air at about 900° C., consequently the electronic component body 11 and the base metal layer 5a are formed.

Next, similarly as in the first and second embodiments, an intermediate metal layer 5b including noble metal, a conductive resin layer 5c including thermosetting resin dispersed with conductive filler, a plating metal layer 5d formed by Ni electroplating, and a Sn plating metal layer 5e are sequentially formed on the base metal layer 5a. The chip resistor 10 obtained in this way provides the same advantages as those in the first embodiment.

### EXAMPLE 1

Dielectric ceramic powder having a temperature characteristic showing the BJ characteristic of JIS was kneaded with polyvinyl butyral, other additives, and solvent so that slurry was formed. Then, the slurry was formed into a ceramic green sheet having a thickness of 5 μm using a doctor blade. Then, a Ni conductive paste was coated on the ceramic green sheet by screen printing to form internal electrodes. The ceramic green sheet was stamped into a predetermined size, and piled such that internal electrodes of 10 layers were formed. Then, the piled internal electrodes were subjected to thermocompression bonding to obtain a layered product. The layered product was cut into a size of about 4.0×2.0 mm. A Ni conductive paste including a common material was coated by dipping on an exposed surface of internal electrode of the cut layered product, then burned in a nitrogen-hydrogen atmosphere at about 1300° C., consequently a multilayer ceramic capacitor body about 3.2×1.6 mm in size having a base metal layer was obtained.

A Cu intermediate metal layer 3 μm in thickness and 100% in continuity modulus was formed on the base metal layer by an electroplating method. Then, a conductive resin including epoxy resin containing Ag as filler was coated by dipping on the Cu intermediate metal layer, and then cured at about 200° C. to form a conductive resin layer. Then, a Ni plating metal layer and a Sn plating metal layer were sequentially formed on the conductive resin layer by the electroplating method.

### EXAMPLE 2

The same multilayer ceramic capacitor body as in the example 1 was prepared, and a Ni intermediate metal layer 3 μm in thickness and 100% in continuity modulus was formed on the base metal layer by the electroplating method. Then, a conductive resin including epoxy resin containing Ag as filler was coated by dipping on the Ni intermediate metal layer, and then cured at about 200° C. to form a conductive resin layer, as in the example 1. Then, a Ni plating metal layer and a Sn plating metal layer were sequentially formed on the conductive resin layer by the electroplating method.

### COMPARATIVE EXAMPLE 1

The same multilayer ceramic capacitor body as in the example 1 was prepared, and a conductive resin including epoxy resin containing Ag as filler was coated by dipping on a base metal layer, and then cured at about 200° C. to form a conductive resin layer. Then, a Ni plating metal layer and a Sn plating metal layer were sequentially formed on the conductive resin layer by the electroplating method.

### COMPARATIVE EXAMPLE 2

The same multilayer ceramic capacitor body as in the example 1 was prepared, and a Ni plating metal layer and a Sn plating metal layer were sequentially formed on a base metal layer by the electroplating method.

The multilayer ceramic capacitors obtained in the example 1, example 2, comparative example 1, and comparative example 2 were prepared by ten, and subjected to a deflection test according to a procedure of the substrate bending resistance test method of JIS-C5101, in which the amount of deflection in capacitance decrease of at least 10% was measured, and then average values for respective 10 samples were calculated. While 3 mm is defined as an upper limit of the amount of deflection in the test method of JIS-C5101, the test was carried out to the amount of deflection of 10 mm, and when decrease in capacitance was not found even if the amount of deflection reached 10 mm, evaluation was made as “the amount of deflection of 10 mm or more”. A result of the deflection test is shown in FIG. 8. This shows that when the comparative example 1, in which the conductive resin layer is directly formed on the base metal layer, is compared to the comparative example 2 in which the conductive resin layer is not formed, deflection strength is lower in the comparative example 1. Observation of terminal electrodes of the multilayer ceramic capacitors used for the test was performed. As a result, it was found that the conductive resin layer was separated from the base metal layer in the comparative example 1. In the example 1 in which the Cu intermediate metal layer was formed between the base metal layer and the conductive resin layer, and the example 2 in which the Ni intermediate metal layer was formed between the base metal layer and the conductive resin layer, decrease in capacitance was not found even if the amount of deflection was 10 mm, consequently deflection strength was able to be improved at least two times compared with the comparative examples. In addition, similar tendency was confirmed in a drop test and a heat cycle test, consequently the terminal electrode structure of an embodiment of the invention was confirmed to be effective for improving mechanical strength.

### EXAMPLE 3

The same multilayer ceramic capacitor body as in the example 1 was prepared, and samples having Cu intermediate metal layers 0.3 μm, 0.5 μm, 1 μm, and 3 μm in thickness (and 100% in continuity modulus) were formed on base metal layers by electroplating with plating time being controlled, respectively. Then, a conductive resin layer, a Ni plating metal layer, and a Sn plating metal layer were sequentially formed on the Cu intermediate metal layer of each sample, as in the example 1.

These samples and samples of the comparative example 1 were prepared by ten respectively, and subjected to a deflection test according to the procedure of the substrate bending resistance test method of JIS-C5101, in which the amount of deflection in capacitance decrease of at least 10% was measured, and then average values for respective 10 samples were calculated. A result of such calculation is shown in Table 1. When decrease in capacitance was not found even if the amount of deflection was 10 mm, evaluation was made as “the amount of deflection of 10 mm or more”.

TABLE 1

| | Thickness of intermediate metal layer | | | | |
|---|---|---|---|---|---|
| | (μm) | | | | Comparative |
| | 0.3 | 0.5 | 1.0 | 3.0 | example 1 |
| Deflection | 5.2 | >10 | >10 | >10 | 5.0 |
| strength (mm) | | | | | |

The result shows that while slight improvement is found in the thickness of 0.3 μm, deflection strength of at least 10 mm, or a significant effect of the intermediate metal layer, is found in the thickness of 0.5 μm or more. Accordingly, thickness of the intermediate metal layer is more preferably 0.5 μm or more. For an upper limit of thickness of the intermediate metal layer, samples were prepared, in which thickness of the intermediate metal layer was further increased to 5 μm, 7 μm, 10 μm, and 15 μm, then the samples were dipped in a solder bath at 270° C. for 3 sec, and then capacitance was measured, and samples in which difference in capacitance between before and after the test was within ±10% were defined to be good. Such measurement was performed for respective 10 samples, and evaluation was made according to 0/1 determination. As a result, while decrease in capacitance was not found in any sample up to the thickness of 10 μm, decrease in capacitance was found in the sample of 15 μm. As a result of analysis, an inside crack was found in the sample of 15 μm. This shows that as thickness of the intermediate metal layer is increased, total thickness of the base metal layer and the intermediate metal layer is increased, thereby thickness of a metal layer to be adhered on the ceramic body is increased, leading to increase in difference of thermal expansion between the ceramic body and the metal layer, and consequently resistance to thermal shock such as solder dip resistance is decreased. Accordingly, an upper limit value of thickness of the intermediate metal layer was defined to be 10 μm.

### EXAMPLE 4

The same multilayer ceramic capacitor body as in the example 1 was prepared, and samples having Cu intermediate metal layers 10%, 20%, 50% and 100% in continuity modulus (and 0.5 to 1 μm in thickness) were formed on the base metal layers by electroless plating while dipping time into plating solution is controlled, respectively. Then, a conductive resin layer, a Ni plating metal layer, and a Sn plating metal layer were sequentially formed on the Cu intermediate metal layer of each sample, as in the example 1.

These samples and samples of the comparative example 1 were prepared by ten respectively, and subjected to a deflection test according to the procedure of the substrate bending resistance test method of JIS-C5101, in which the amount of deflection in capacitance decrease of at least 10% was measured, and average values for respective 10 samples were calculated. A result of such calculation is shown in Table 2. When decrease in capacitance was not found even if the amount of deflection was 10 mm, evaluation was made as “the amount of deflection of 10 mm or more”.

TABLE 2

| | Continuity modulus of intermediate metal | | | | |
|---|---|---|---|---|---|
| | layer (%) | | | | Comparative |
| | 10 | 20 | 50 | 100 | example 1 |
| Deflection | 5.8 | >10 | >10 | >10 | 5.0 |
| strength (mm) | | | | | |

The result shows that while slight improvement is found in the continuity modulus of 10%, deflection strength of at least 10 mm, or a significant effect of the intermediate metal layer, is found in the continuity modulus of about 20% or more. Accordingly, a continuity modulus of the intermediate metal layer is more preferably 20% or more.

### EXAMPLE 5

The same multilayer ceramic capacitor body as in the example 1 was prepared, and samples having Ag intermediate metal layers 0.3 μm, 0.5 μm, and 1 μm in thickness (and 100% in continuity modulus) were formed on base metal layers by a sputtering method with deposition time being controlled, respectively. Then, a conductive resin layer, a Ni plating metal layer, and a Sn plating metal layer were sequentially formed on the Ag intermediate metal layer of each sample, as in the example 1.

These samples and samples of the comparative example 1 were prepared by ten respectively, and subjected to a deflection test according to the procedure of the substrate bending resistance test method of JIS-C5101, in which the amount of deflection in capacitance decrease of at least 10% was measured, and then average values for respective 10 samples were calculated. A result of such calculation is shown in Table 3. When decrease in capacitance was not found even if the amount of deflection was 10 mm, evaluation was made as “the amount of deflection of 10 mm or more”.

TABLE 3

| | Thickness of intermediate metal layer | | | |
|---|---|---|---|---|
| | (μm) | | | Comparative |
| | 0.3 | 0.5 | 1.0 | example 1 |
| Deflection | 5.4 | >10 | >10 | 5.0 |
| strength (mm) | | | | |

The result shows that while slight improvement is found in the thickness of 0.3 μm, deflection strength of at least 10 mm, or a significant effect of the intermediate metal layer, is found in the thickness of about 0.5 μm or more.

While the examples were described with the multilayer ceramic capacitor as an example, similar advantages can be obtained in the multilayer inductor and the chip resistor. In a multilayer varistor, multilayer thermistor or the like, since only a ceramic material is different from the multilayer ceramic capacitor, and a structure is the same as that of the capacitor, similar advantages of the invention are obviously obtained. The same is true in a component having multiple terminals such as a capacitor array. While metal species of the intermediate metal layer were described using the intermediate metal layer of Cu, Ni or Ag, the same is true in an intermediate layer of another metal such as Pt, Pd or Au.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A surface-mounting ceramic electronic component having an electronic component body, and at least a pair of terminal electrodes formed on a surface of the electronic component body, wherein each of the terminal electrodes comprises:
a base metal layer comprising a ceramic powder or glass frit,
an intermediate metal layer formed on the base metal layer throughout a conductive resin layer formed on the intermediate metal layer, and
a plating metal layer formed on the conductive resin layer.

2. The surface-mounting ceramic electronic component according to claim 1:
wherein the intermediate metal layer has a thickness of about 0.5 μm to 10 μm.

3. The surface-mounting ceramic electronic component according to claim 1:
wherein the intermediate metal layer has a continuity modulus of at least 20%.

4. The electronic component of claim 1, wherein the intermediate layer comprises one or more of the following metal: Au, Pt, Pd, Ag, and Cu.

5. A method of making a surface-mounting ceramic electronic component having an electronic component body, and at least a pair of terminal electrodes formed on a surface of the electronic component body, the method comprising, for each internal electrode:
forming a base metal layer comprising a ceramic powder or glass frit,
forming an intermediate metal layer on the base metal layer, and
forming a conductive resin layer on the intermediate metal layer.

6. The method of claim 5, the method further comprising, for each internal electrode, forming a plating metal layer on the conductive resin layer.

7. A terminal electrode suitable for being used in a surface-mounting ceramic electronic component, the terminal electrode comprising:
an intermediate metal layer formed between a base metal layer and a conductive resin layer.

8. The terminal electrode of claim 7, wherein the intermediate metal layer has a smoother and tighter metal surface than the base metal layer.
